(19) United States
(12) Patent Application Publication
(10) Pub. No.: US 2001/0037407 A1
(43) Pub. Date: Nov. 1, 2001

(54) System and method for managing user-specific data

(76) Inventors: Zvetan Dragulev, Vienna (AT); Barnabas Mink, Vienna (AT)

Correspondence Address: BAKER & MCKENZIE, 805 THIRD AVENUE, NEW YORK, NY, 10022, US

(21) Appl. No.: 09/815,610

(22) Filed: Mar. 23, 2001

Related U.S. Application Data
(60) Provisional application No. 60/191,614, filed on Mar. 23, 2000.

(51) Int. Cl. G06F 15/16

(52) U.S. Cl. 709/250; 709/227

(57) ABSTRACT

A system and method for managing user-specific data communicated over a network independent of devices used to communicate. The user profile or preference data specific to a user is automatically detected, extracted and stored in a server independent of the device used by a user to communicate. The next time the user communicates from any device to the same domain or application, to exchange information, the stored user profile or preference data is retrieved and used during the communication.

### CROSS-REFERENCE TO RELATED APPLICATIONS

This application claims the benefit of U.S. Provisional application Ser. No. 60/191,614, filed Mar. 23, 2000.

### TECHNICAL FIELD OF THE INVENTION

The present invention relates to a computer system and method for managing user-specific data over multiple devices. The user-specific data includes the information communicated over a data/communications network, e.g., over the Internet.

### BACKGROUND OF THE INVENTION

The Internet

The Internet is a global communications medium enabling millions of people to share information and conduct business electronically. The dramatic growth in the number of business and consumer Internet users has led to a proliferation of useful information and services on the Internet, including electronic mail (“e-mail”), news, electronic commerce, educational and entertainment applications, and a multitude of other value-added services. As a result, the Internet has become a primary and ubiquitous daily resource for millions of people.

The Internet comprises a vast number of computers and computer networks that are interconnected through communication links. The interconnected computers exchange information using various services, such as e-mail and the World Wide Web (“WWW”). The WWW service allows a server computer system (i.e. Web server or Web site) to send graphical Web pages of information to a remote client computer system. The remote client computer can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hyper Text Transfer Protocol, “HTTP” request). If the client wants to download a file from a FTP (i.e., File Transfer Protocol) server, it does so via the file's FTP URL. The request is forwarded to the Web server that supports the Web page. When that Web server receives the request, it sends that Web page to the client computer system. It is also possible that the server returns not only the requested resource but also additional data that has to be interpreted by the networking application that requested the resource. For example, the HTTP protocol defines so called HTTP cookies. Cookies are bits of code that servers use to store data on clients that can be retrieved later by the same server system, either within the same session or during a later one. When the client computer system receives a Web page, it typically displays the Web page using a browser. A browser is a special purpose application program that effects the requesting of Web pages and the display of Web pages.

Currently, Web pages are typically defined using Hyper Text Markup Language (HTML), but there are also other standards emerging such as XML for electronic commerce and data forms, as well as wireless application markup languages and others. Markup languages provide a standard set of tags, which are inserted in a file that specify how the file, or a portion of the file, should be formatted and interpreted.

Applications of the Internet

Apart from being a communications network such as the old voice networks of the telephone age (e.g., e-mail, chat, voice over data, etc), the WWW is especially conducive to conducting electronic commerce. Many Web servers have been and are being developed through which vendors can advertise and sell products and services. The products and services can be delivered electronically to the consumer (entertainment, e.g., music; subscriptions, e.g., news; applications, e.g., personal online organizer; etc) or through conventional distribution channels (e.g., books delivered by a common carrier).

Services over the Internet will introduce the most innovative elements. So-called Application Service Providers (ASPs) are hosting software applications on Web servers that can be accessed and used over the Internet. Hosted applications can be targeted at individual customers in the business-to-consumer (B2C) space, or at corporate customers in the business-to-business (B2B) field.

B2C ASPs can offer services over the Internet such as financial portfolio software (e.g., Quicken by Intuit), personal organizer and planner (e.g., My Yahoo by Yahoo), Internet e-mail (e.g., Hotmail.com by Microsoft), navigation systems (e.g., MapQuest.com), Internet file directories (file storage/backup on the Internet, e.g., Netdocuments.com or Visto.com). These B2C applications over the Internet have certain advantages over classical client computer-based software. The user can access the applications from anywhere in the world and from any Internet enabled device. The user is safe from loss of his/her client computer and does not need to spend resources on maintenance and upgrades.

B2B ASPs are also offering high value propositions to clients such as Back-Office applications spanning from hosted mail-servers (e.g., MS Exchange) to financial and human resource applications (e.g., ERP applications from vendors such as SAP, PeopleSoft, Siebel, etc.). These applications can then be accessed from Internet terminals. In certain cases users have restricted access, e.g., cases can only use client devices behind a certain firewall, etc.

Messaging services over the Internet are enabling users of both corporate and private nature to communicate more efficiently and conveniently, through e-mail, chat, voice or video.

Expansion of the Internet

The Convergence of the Internet and Wireless Networks

As people have become increasingly dependent on e-mail services, remote access to corporate intranets and other Internet-based services, mass market wireless devices that provide mobile access to these resources have become increasingly useful tools.

To provide a worldwide open standard enabling the delivery of Internet-based services to mass-market wireless telephones, the Wireless Application Protocol (WAP) Forum publishes technical specifications for application and content development and product interoperability based on Internet technology and standards. By complying with WAP specifications, wireless telephone manufacturers, network operators, content providers and application developers can provide Internet-based products and services that are interoperable. There are rapidly many other wireless Internet standards emerging, especially for high-bandwidth wireless technologies.

Internet Information/Communication Devices

The advent of the wireless Internet is supported by a whole range of different wireless Internet devices, such as Internet phones, Internet enabled Personal Digital Assistants (PDAs), Internet-enabled car information systems, watches, etc.

In parallel to the wireless developments, wired Internet-Terminals of different kinds are being developed. So-called Thin-clients or Network Computers (NCs) are replacing the traditional PC for many functions. Television sets can either have integrated Internet support or connect through so-called set-top boxes. Game-console, which have traditionally been bound to local players, are developed with Internet support in order to make global network games possible.

In addition, modern Internet standards are also independent of any particular device (e.g., WAP specifies the bare minimum functionality a device must have, and has been designed to accommodate any functionality above that minimum).

Device independence offers similar benefits to bearer independence: applications developed for one standard can operate on a wide variety of devices that implement the specification; network operators gain a consistent user interface for their services across multiple vendors' devices; application developers do not have to write separate versions of their code for different devices, and service providers can choose any standard compliant device that meets their own unique market requirements. Device manufacturers are assured that they will have many applications written for their device by implementing the specification.

Challenges for an “Invisible Internet”

The Back-End

There are still many hurdles and technological challenges to be mastered before the Internet becomes seamless to use and hence “invisible”. Internet devices can, through the application of Industry Standards (e.g., HTML, WML, XML, etc.), communicate with each other over networks—however, as these devices grow in number there will be increasing demand for services over networks. Servers that provide services to client-devices have to be reliable, secure and fast. Modern computer systems therefore avoid single-points of failure through the use of distributed software and data-environments. They use software to distribute the work across many different systems, so that in the event that one of those systems went down, the application or database would still be up and running for the client-user. This approach is also called software scaling.

Network Capacity

On corporate networks, the Internet and the global wireless network today, many applications and data-transfers are not being enabled because of fear of network congestion, which can threaten more critical transactions that are going across the network. In many cases this is not due to lack of bandwidth, which is being added increasingly. One bottleneck is lack of prioritization. Modern network environments are capable of setting policies and priorities for individual clients or applications. However, this does not help the latency problem of congestion on servers.

One of the most promising approaches to network efficiency is caching (formerly only used in local, closed systems). Network caching brings two main benefits: improved response times and more efficient use of bandwidth. Deploying a cache significantly reduces the response-time problem by storing Web objects closer to end-users. If the requested objects are in the cache, they get the information almost instantaneously, while requests that have to go to the origin server typically take longer to be fulfilled. Second, caches reduce traffic. When users get objects from caches, they do not use as much bandwidth as if the object came from the origin server. However, caching introduces the problem of the cache consistency. For example, the network caching technologies must be able to ensure that the data in the cache represents the latest version.

Security

In the digital realm, security issues are manifold. With the increase of network applications and client-devices, authentication and privacy reassurance become critical to consumer acceptance and commercial success. Firewall and encryption technologies are protecting network servers and users from hacker attacks. Authentication technologies such as fingerprint, voice or even DNA recognition can be applied in order to verify users of network devices. Software can be built that protects systems from viruses, monitoring or tracking software that can be “pushed” to clients.

User Identifiers

Despite increased network enabled information devices such as PCs, PDAs and phones and despite increased levels of application and data-transfer reliability and security, issues such as ease of use of applications and devices remain the main challenge for innovation. One example of user inconvenience is the lack of a universal network-based user identification/authentication, as opposed to client-centric identification/authentication. In many cases users are asked to provide different user names and passwords at different servers. This holds true for all kinds of personalized/customized configuration parameters and data, be it web addresses, alarms or alerts, e-mail or other communication. Client identifiers, cookies in many cases, can be saved by client systems for automatic authentication. However that method is client-based and will not work on different client devices unless every authentication process is repeated for each device. The same is usually true for all configuration settings and personal profile parameters. Smart cards are another example of a client-centric identification-authentication system, where configuration parameters and data are stored on a chip. However, loss or damage to the smart card can cause severe user inconvenience.

Therefore, new systems and methods are needed for the integration of client-centric and network-centric user and client identification and authentication. Preferably, these systems and methods should enable users to use any network enabled information device with their personalized configuration parameters and application settings.

### SUMMARY OF THE INVENTION

The present invention relates to a computer system and method for managing user-specific data over multiple devices. The user-specific data, e.g., includes unique information that relates to a user and communicated over a data/communications network, e.g., over the Internet. The invention enables a unique user registration, e.g., for Internet-enabled devices that can provide users with their personal configuration and application settings, independent of particular machines that the users employ to connect to a network, e.g., the Internet. The present invention thus supports the collection and deployment of unique user preferences over multiple devices and network.

The system of the present invention includes a profile client associated with a user device. The user device typically includes a software interface, e.g., a browser, for accessing one or more other nodes on a network, e.g., one or more web servers or web sites on the Internet. A profile application programming interface allows the profile client to access user-specific data from a profile server. The profile client retrieves the user-specific data associated with a user currently logged into the user device. The user-specific data is retrieved from the profile server, e.g., by using utilities provided by the profile application programming interface. The profile client stores the retrieved user-specific data on the user device to be used as user-specific data for the user when communicating to different nodes or web sites during the time the user is logged into the user device. The profile client also intercepts the data communicated from the user device to the nodes or web servers, and insert the user-specific data, if any, in the data before the data is communicated to the nodes or web servers.

The profile client also intercepts data communicated from the nodes or web servers to the user device, and extracts the user-specific data, if any, to store the user-specific data in the profile server. This way, the user-specific data is preserved over multiple user sessions, independent of devices that the user uses to communicate on a network, e.g., the Internet.

The present invention in one embodiment also synchronizes the user-specific data residing locally with those stored in the server. The user-specific data stored locally is monitored for any changes during a user session. When a change is detected the data is resynchronized, e.g., by transmitting the changed date to the server for updating of the data.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 illustrates a flow diagram of a profile filter in one embodiment of the present invention;

FIG. 2 illustrates the tasks of a profile client during a session in one embodiment of the present invention.

FIG. 3 shows three classes of profile clients in one embodiment of the present invention.

FIG. 4 is a diagram illustrating the profile collector of the present invention in one embodiment;

FIG. 5 is a diagram illustrating the functions of the profile filter of the present invention in one embodiment;

FIG. 6 illustrates the architectural diagram of the PAPI of the present invention in one embodiment; and

FIG. 7 illustrates a flow diagram of the present invention for processing cookie applications in one embodiment.

### DETAILED DESCRIPTION OF THE INVENTION

The present invention is related to a system and method for client-independent management, storage and retrieval of user-specific information/data over a distributed database environment via a communications network.

The present invention in one embodiment centralizes storage of user-specific data, e.g., profile data; enables users to use their personalized web pages from every machine/device they work on and manages the user-specific data seamlessly.

The following terminology is used for describing the present invention in one embodiment.

Terminology

User Profile

Term for all information stored for a specific user. A user profile is organized into profile chunks of previously defined chunk classes.

Profile API (PAPI)

The PAPI refers a well-defined interface for programmers for using the profile servers, providing functions for query/storage of profile information, installation of callback functions, as well as creation of new chunk classes. It handles and/or hides the low-level communication to the profile servers, etc.

Profile Chunk

The profile chunk is the smallest entity of profile information, representing any data structure, like bookmarks, cookies, memos, alerts, etc. Chunk class data type may be a named struct of named variables.

Callback

The PAPI also provides a callback mechanism, which means that the programmer can install functions to be called upon profile events.

Profile Event

A profile event is fired when a predefined action takes place, e.g., a new chunk of a specific class is created, e.g., a message, a timeout occurs, e.g., an alert, etc.

Profile Filter

A profile filter is software that resides between the Internet and the Internet software, e.g., a browser. It runs either locally on the user's device such as a Personal Computer (“PC”), notebook, mobile phone, or on a server, e.g., a proxy mechanism.

Profile Collector

In certain cases, e.g., bookmarks, a profile filter may not be sufficient for collecting the information of a user. In these cases, a profile collector extracts the profile information from the local storage, e.g., hard-disk, chip-card, etc., and sends them to the profile server. Upon session start, the local data is synchronized with the data in the profile database.

Profile Server

A profile server holds the chunks as well as the chunk class definitions. There can be more than one profile servers, which together form the profile database. Profile client is a software that uses the PAPI. For example, profile collectors and profile filters may function as profile clients.

Profile Migration

The profile of a specific user is always stored on one server at a time, usually the nearest one. When the user accesses his profile using another server, his profile migrates to that server secure connection used for communications between the clients and the servers as well as between the servers.

Session

The interval between login and logout. The duration of a session can be chosen by the user, e.g., per browser, per uptime, etc.

Light Version

A fast and easy to install collection of the most popular profile filters/clients and the PAPI web interface. The profile servers provide a web interface to users for editing their profile information, e.g., chunks.

The present invention in one embodiment may include the following components.

Components

The Profile Application Protocol Interface (API) provides a set of functions for profile information management, session management (which also means security/access control) and profile event management. It hides the communication between the machine/device and the server(s).

PAPI is typically used for profile management. This means that a profile client may perform profile management by implementing the protocol of the profile servers directly.

Every application that uses the services of a Profile Server is called a profile client. Profile clients include Profile Filters and Profile Collectors. These are programs that enable the use of the profile servers with software that doesn't support the profile management natively.

Profile Filter

A filter component is an intermediate link between the networking application and the server it is communicating to. It therefore sees every request made by and any answer sent to the application. Whenever the client detects profile information in the data sent from a server to the application, it extracts this profile data and stores it on the profile server it is communicating with. If the filter uses the PAPI, this simply means that it hands over the data to the PAPI, by calling the appropriate functions. Whenever the networking application sends a request to a server, the filter component inserts profile data into that request, if appropriate and/or any.

In one embodiment, a filter does not have to run on the same machine/device as the Internet software, but may also run, for example, on a gateway (intermediate server).

Profile Collector

A collector component works similar to a profile filter. The collector may also run concurrently to the Internet software (in background, occupying as little system resources as possible), monitoring changes of the profile data stored locally, e.g., as registry and/or files. Whenever the collector notices a change in the profile information, it extracts the data and stores it on the profile server, for example, by giving it to the PAPI. An example of the Internet software includes a browser which is typically a program which allows a person to read hypertext. Browser enables viewing the contents of pages located at a computer node and of navigating from one node to another.

Server

The server component runs one or more Internet servers, e.g., forming a distributed profile database.

The server component typically waits for connection requests made by clients. Clients may send/request profile data to the server, as well as perform profile data management, e.g., delete/modify data, etc. A typical case of sending profile data from the server to the client components is when a user session starts. On login, the client side “synchronizes” the profile information of the user with the information stored locally, if any, and the server information. The server also stores the machine independent settings of the user. The server may also connect to the client side, e.g., when a profile event that the client side is interested in occurs.

Security Issues

The server and its clients communicate with each other by using a communications protocol. Since the data is sent over the Internet, which is typically considered as being insecure, in one embodiment, the data is encrypted to ensure security and to make sure that the authentication of the clients is ‘cracker-safe’. In one embodiment, an open and well-known cryptographic algorithm is used to implement these security measures.

Session Management

In the present invention, a user logs in to the profile server for a session duration. In one embodiment, a session is defined as a period between a system startup until the machine/device is turned off. This embodiment is ideal for machines/devices that are used by the same person between startup and shutdown.

In another embodiment, a session is defined from the start of the networking software to the closing of it. This embodiment accommodates multi-user machines, such as Personal Computers (“PCs”), e.g., in Internet bars, libraries, etc. It is likely that many users would want to use the profile services with such machines. In this embodiment, the user typically quits the software before he leaves the machine and another user starts working on it.

In another embodiment, a session is defined for a predefined time period. For example, when a specified amount of time elapses without any request from the browser, the session ends automatically or times out.

Each embodiment for defining a session in the present invention has its advantages. The present invention is enabled to support all the embodiment as needed by the client to support all session management modes, allowing the user to choose between them, and/or combine them, e.g., with a timeout feature.

Light Clients

In the present invention, a “light” client is a small, fast downloading, extremely easy to install client, that implements the profile communications protocol directly. The light client typically does not need a PAPI installation on the machine/device. Light clients are well suited for users who are working on multiple machines, for example, with multiple-user devices.

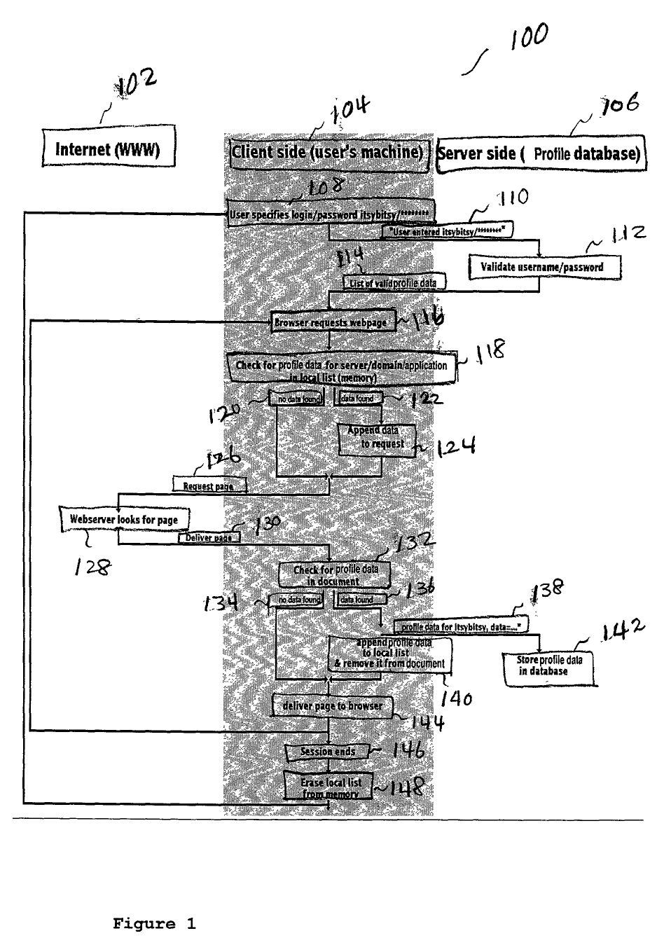

FIG. 1 illustrates a flow diagram 100 of a profile filter in one embodiment of the present invention. In this embodiment, the profile filter of the present invention is used with a Web browser accessing the Internet 102 to manage user profile data, e.g., stored in a profile server 106, during, e.g., an Internet navigation session from a user machine 104. In an exemplary embodiment, a browser is configured to use a proxy, on a local-host and a specific port. Initially, a user supplies a user identifier and password to the system of the present invention to identify the user as shown a 108. Supplying of this user identifier and password may also be done automatically, e.g., when a user logs on to a user's machine. For example, the user identifier and password may be automatically read from a file instead of prompting the user to enter the user identifier and password. At 110, the user identifier and password is transmitted to a profile server 106 of the present invention. The profile server 106 validates the data at 112. The profile server 106 may also locate user profile data associated with the validated user identifier and password in its database storage. The profile server 106 may then also transmit the user profile data to the profile client residing in the user's machine 104 for local caching or storage as shown at 114. At this point, the user's machine includes the user profile information in its local cache or storage.

When a user requests a web page, e.g., by using a web browser as shown at 116, the client profile of the present invention, e.g., a client filter, intercepts the browser request and determines at 118 whether the domain requested via the browser, e.g., URL, is associated with any user profile data stored in the local cache or storage. An example of a URL and associated profile data is a web site that requires a user to register its name for the first time the user logs on to that particular web site. Typically, when a user logs onto the same web site subsequently, the web site would not prompt for new user registration. This is so, because the web site stores a profile data in the user's machine so that the web site would recognize that the user has already registered for this web site. At 122, if the client filter of the present invention finds a user profile data associated with the requested domain, the client filter at 124 includes that user profile data with the domain request and posts the request to the Internet at 126. At 120, if no user profile data is found, then a normal request is posted on the Internet at 126.

At 128, a web server at the requested domain looks for the requested page and at 130 delivers the page to the client 104. At this point, the web server may have inserted a profile data specific to the user in the page being delivered. Accordingly, at 132, the client filter of the present invention checks for any profile data that may have been included in the page or document being delivered, e.g., by parsing the page or document. At 136, if user profile data is found, the client filter at 138 transmits the user profile data to the profile server for storage in the profile database at 142. At 140, the profile data may also be stored locally on the client machine 104. Also, optionally, the profile client may remove the profile data from the document.

At 144, the requested web page is delivered to the web browser for display or presentation on the client machine. The session described above may continue until the user logs off the client machine. When the session ends 146, the local cache or memory may be erased or cleaned, e.g., for another user with different set of profile data as shown at 148.

The client side, e.g., the profile client, may be configured completely web-based, i.e., web browser-based. When a user enters a specific URL, e.g., http://configure, the client generates and sends back a configuration page with its settings to the user. There may be two categories of configuration data: 1) machine specific, stored locally such as in the session management mode; 2) machine independent, stored on the server such as deny lists, etc. Deny list, e.g., may include a list of addresses or names of senders whose cookies the user would like to filter out. When the user logs in, the client also reads these settings from the server. According to the present invention, these settings are bound to the user, and not to the computer system or device.

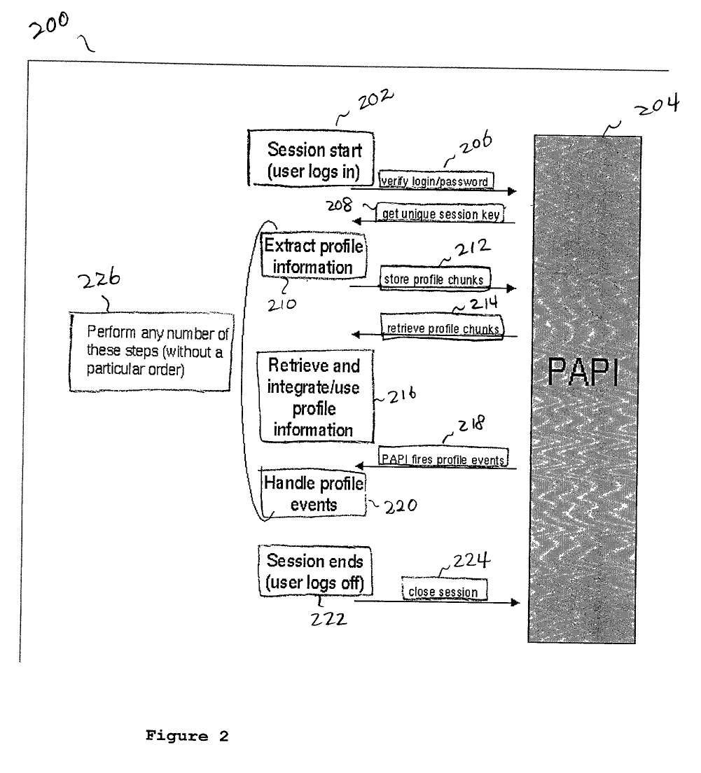

FIG. 2 illustrates the main tasks of a profile client during a session in one embodiment of the present invention. At 202, a session starts, e.g., when a user logs in. The profile client of the present invention uses the profile application programming interface (PAPI) 204 to access the profile server and its database. At 206, a user identifier and password are transmitted to the profile server via the PAPI 204 for validation. The profile client at 208 receives a unique session key for use during the session for this particular user. Any number of steps at 210 to 220 may be performed during the session as shown at 226 without a particular order. At 210 the profile client extracts profile information for use during the session. At 212 the profile chunks may be stored at a profile server database via the PAPI 204. At 214 the profile chunks may be retrieved from a profile server database via the PAPI 204. At 216, the profile client retrieves and uses the profile information, e.g., by integrating the information into a web page request.

The profile client may also be used to handle profile events as shown at 220. An example of a profile event includes an expiration of selected user profile data. For example, certain user profile data may have an expiration time associated with it such that it should only be used for a certain period of time. When that time expires, the profile server via the PAPI 204 notifies the profile client of the expiration by posting an event 218. The profile client responds by either not using that data or alternatively, deleting the data from the local cache or storage. At 222, when the session ends, e.g., when a user logs off, the client profile sends a message to the profile server via the PAPI 204 to close the session.

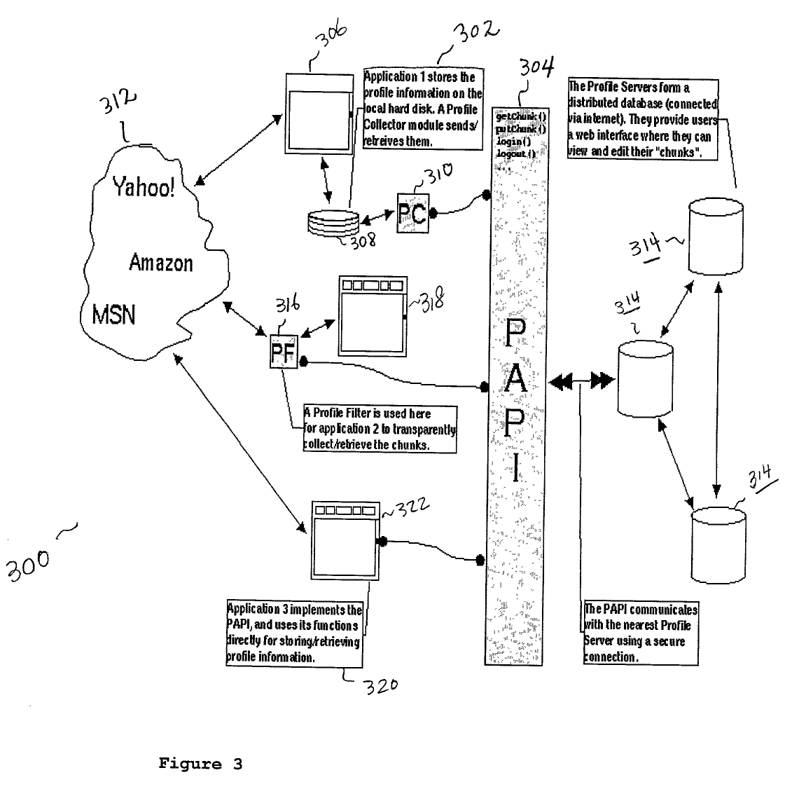

FIG. 3 shows three classes of profile clients in one embodiment of the present invention. One type of a profile client, shown at 302, periodically collects and stores the profile information locally, e.g., on a personal computer(“PC”) 310, or a non-volatile storage 308 connected locally to the personal computer 310. These information may be used, e.g., when a user communicates to the Internet 312 via the PC 310. The information is collected, e.g., via the PAPI 304 from one or more profile servers 314 of the present invention. The profile servers 314 may be distributed over network as shown, or alternatively, the profile server 314 may be a centralized server. The communication via PAPI 304 to the profile servers may be web-based, where users are enabled to view and edit their profile data or chunks. In one embodiment, PAPI 304 communicates with a nearest profile server 314 using any known secure connection mechanism.

Another example of a profile client is a profile filter. The functions of the profile filter 316 were described in detail with reference to FIG. 1. The profile filter 316 may be used to transparently collect and/or retrieve the chunks or profile data from the profile servers 314 via the PAPI 304. The profile filter 316 also retrieves and stores user profile information in the data exchanged, e.g., between a user's browser 318 and the third party web servers 312.

Yet another example of a profile client is a native application. A native application, e.g., may be implemented to use the functions of PAPI 304 for retrieving, storing, and managing the user profile data from the profile server database 314 and/or the profile server. These applications 320 may also include a web interface 322 for communicating to the profile servers 314 and other web servers 312 on the Internet.

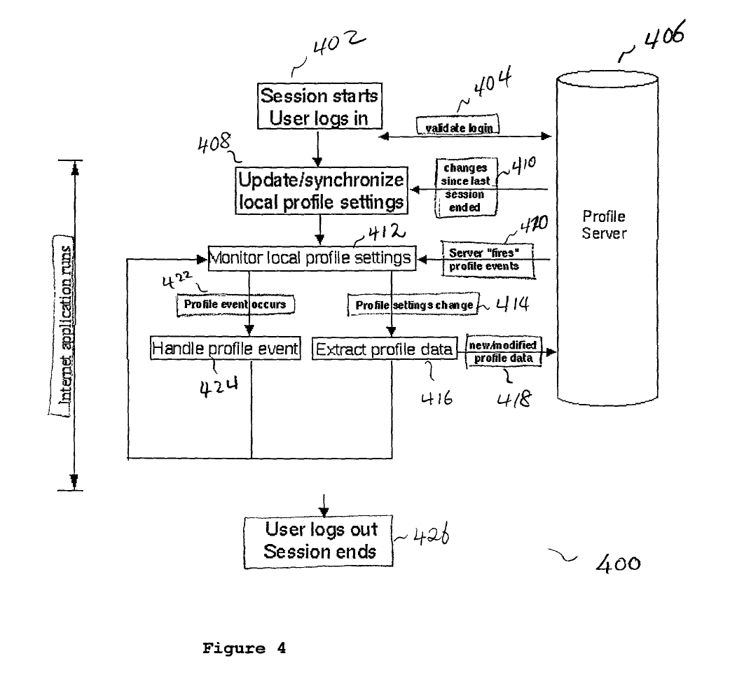

FIG. 4 is a diagram 400 illustrating the profile collector in one embodiment of the present invention. The profile collector may be a program that is run periodically to collect user profile data. Alternatively, the profile collector in the present invention may run continuously in the background, e.g., as a daemon process, monitoring various user profile data. Examples of user profile data include bookmarks, personal address books, etc, that store user preference data or user specific data and which may be updated or modified by a user.

When a user logs in 402, login validation occurs for a given session at 404, e.g., by communicating a user identifier and password to the profile server 406. At 408, the local profile settings are synchronized and/or updated with those stored in the profile server 406. For example, the profile server 406 may transmit the updated or changed profile data since the last session to the profile collector as shown at 410. At 412, the profile collector may monitor the local profile data or settings for changes that occur. At 414, when a change in the profile setting is detected, the profile collector extracts the modified profile data at 416 and transmits the modified profile data to the profile server 406 for storage.

The profile collector of the present invention may also handle profile events. For example, when data stored in the profile server 406 changes or expires, the profile server 406 may signal a profile event as shown at 420. The profile collector receives the profile event and handles it accordingly at 424. For example, a changed data may be updated or an expired data may be deleted or marked as expired. The profile collector's session may end at 426 when the user logs off.

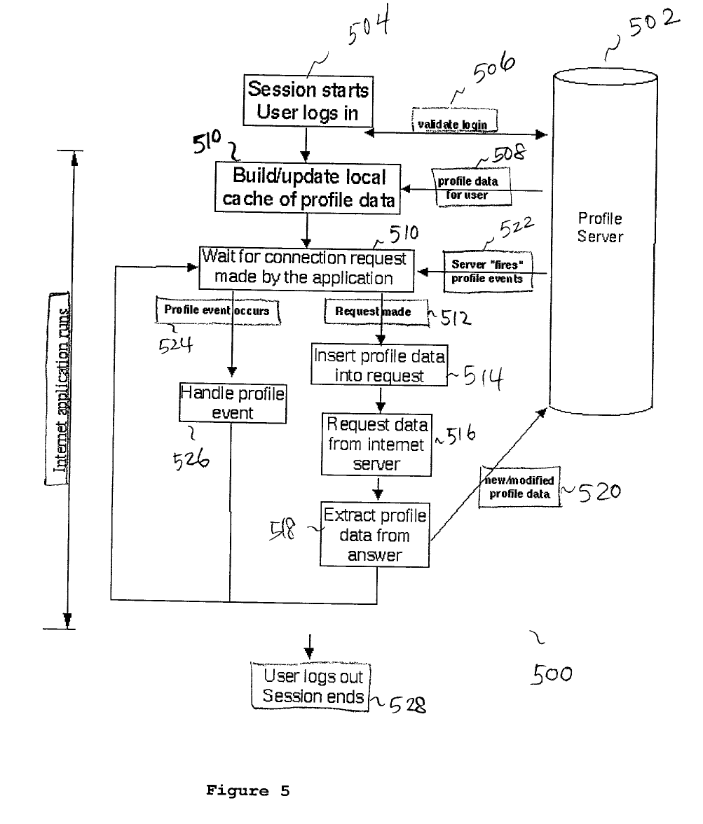

FIG. 5 is a diagram 500 illustrating the functions of the profile filter of the present invention in one embodiment. At 504, a session starts when a user logs in. At 506 the user login is validated with the profile server 502, e.g., by checking the user name and password. Any User validation and authentication methods are widely known to those skilled in the art, and any known methods may be used to validate and/or authenticate the user identity. The profile filter at 508 receives the profile data associated with the user and at 510 builds or updates a local cache or storage of profile data on a user machine or device. At 510, the profile filter then waits for connection requests, e.g., web page requests by a web browser to occur. When a request is detected in an application at 512, e.g., the web browser, the profile filter determines the user profile data associated with this request and inserts the user profile data to the request. The user profile data was previously built or updated in the local cache or storage. Additionally, at 516 when the requested data is received at 516, e.g., a web page from a web server via the Internet, the profile filter at 518 extracts any user profile data or user-specific data from the received web page. The extracted user profile data is then transmitted at 520 to the profile serve 502 for storage. The extracted user profile data may also be stored in the local cache or storage.

The profile filter, similar to the profile collector, may also receive and handle profile events. When the profile server 502 signals any profile events at 522 or when a profile event occurs locally as shown at 524, the profile filter handles the profile at 526. The session ends when the user logs off as shown at 528.

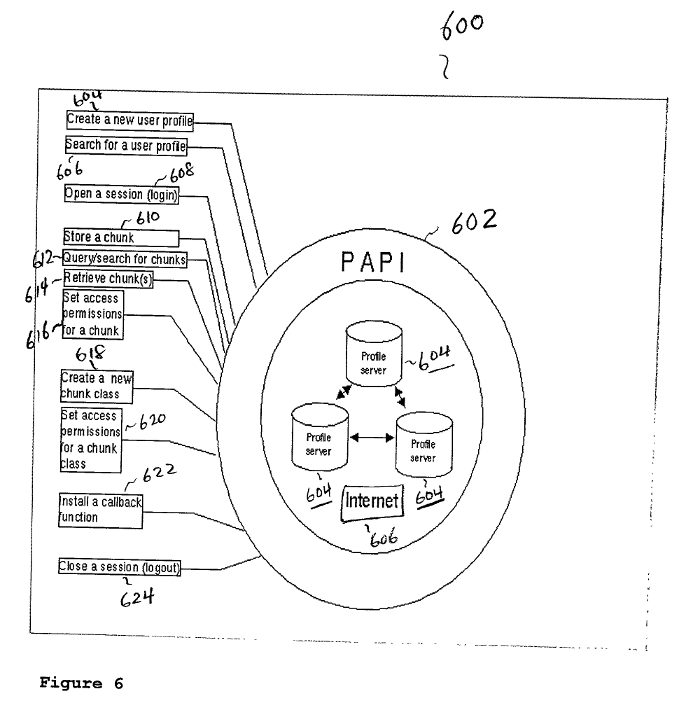

FIG. 6 is an architectural diagram 600 illustrating the PAPI of the present invention in one embodiment. As described herein above, PAPI 602 is a profile application programming interface providing utilities for communicating between the profile clients and the profile servers 604 of the present invention and allowing access to the profile server database that stores user-specific data. The one or more profile servers 604 in the present invention may reside in a node on the Internet 606.

The functionality may be divided into several sections, e.g., “session management”, “chunk management”, “chunk class management”, “profile event handling”. Examples of the utilities provided by PAPI 602 in the present invention include creating a new user profile 604. The new user profile may be created, e.g., by creating a user identifier, password and any associated users-specific data, if any, in the profile server database. A user profile may be searched using the search for a user profile utility 606. A session may be opened by the open a session (login) utility 608. The user profile data may be stored in the profile server 604 by using the store a chunk utility 610. A search for selected profile data may be performed by using the query/search for chunks utility 612.

The profile data may be retrieved from the profile server by using the retrieve chunk(s) utility 614. Access permission on the profile data may be set by using the set access permissions for a chunk utility 616. This utility allows users with certain privileges on selected chunks or profile data. Create a new chunk class utility 618 may be used to define or create a type of user profile data. The set access permissions for chunk classes utility 620 may be used to set access permission on different types of user profile data.

The PAPI 602 of the present invention also allows profile client to set a call back function, e.g., a function to be executed by the profile server 604 on an occurrence of a condition. The call back function may be set by using the install a callback function utility 622 to define the function as well as the condition for triggering the function. The close a session (logout) utility 624 is used to close a session. A person of ordinary skill in the art will appreciate that the functions and utilities provided by an application programming interface are not limited only to these but may also include additional utilities for managing data in general.

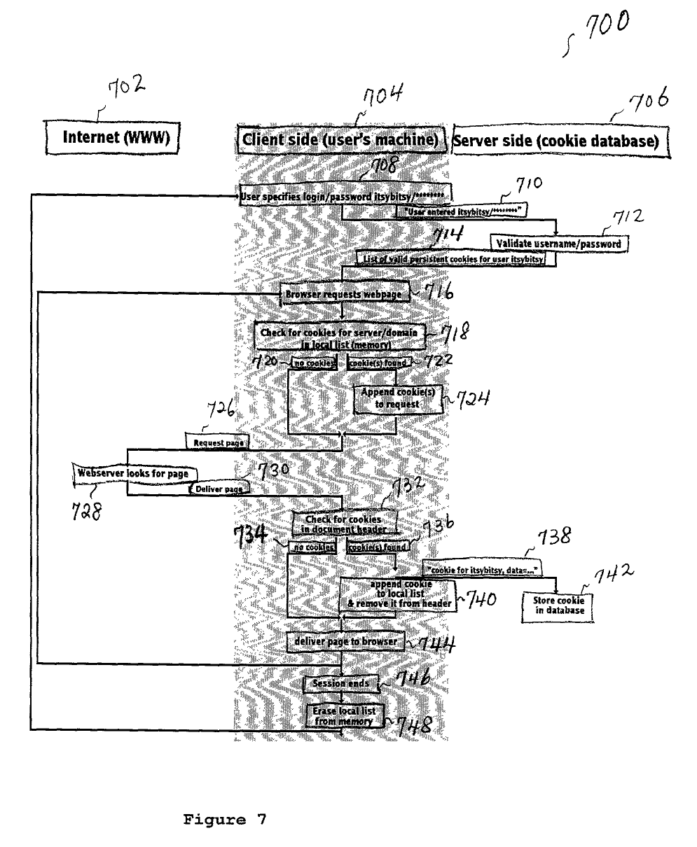

FIG. 7 illustrates a diagram 700 of the present invention for processing and managing HPPT cookies. In the embodiment shown in FIG. 7, the client filter of the present invention intercepts web cookie data from the information flow between a user's web browser and the Internet.

Initially, a user supplies a user identifier and password to the system of the present invention to identify the user as shown a 708. Supplying of this user identifier and password may also be done automatically, e.g., when a user logs on to a user's machine. For example, the user identifier and password may be automatically read from a file rather prompting the user to enter the user identifier and password. At 710, the user identifier and password is transmitted to a profile server 706 of the present invention. The profile server 706 validates the data at 712. The profile server 706 also may locate cookie data associated with this user. The profile server 706 may then also transmit the user profile data to the profile client residing in the user's machine 704 for local caching or storage as shown at 714. At this point, the user's machine 704 includes the web cookie information associated with the user in its local cache or storage.

When a user requests a web page, e.g., by using a web browser as shown at 716, the client filter in the present invention, intercepts the browser request and determines at 718 whether the domain requested via the browser, e.g., URL, had previously associated a cookie for this user by searching the local cache or storage. At 722, if the client filter finds the web cookie information associated with the requested domain for this user, the client filter at 724 includes that cookie data with the domain request and posts the request to the Internet at 726. At 720, if no cookie is found, then a normal request is posted on the Internet at 726.

At 728, a web server at the requested domain looks for the requested page and at 730 delivers the page to the client 704. At this point, the web server may have inserted another cookie data specific to the user in the page being delivered. Accordingly, at 732, the client filter of the present invention checks for any cookie data that may have been included in the page or document being delivered. The profile filter may check for cookies, e.g., by parsing the data received from the web server. When found, the profile filter extracts the cookie data from the received data. At 736, if cookie data is found, the client filter at 738 transmits the cookie data to the profile server for storage in the profile database at 742. At 740, the profile data may also be stored locally on the client machine 704. Also, optionally, the profile client may remove the profile data from the document.

At 744, the requested web page is delivered to the web browser for display or presentation on the client machine. The session described above may continue until the user logs off the client machine. When the session end 746, the local cache or memory may be erased or cleaned, e.g., for another user with different set of profile data as shown at 748.

While the invention has been particularly shown and described with respect to a preferred embodiment thereof, it will be understood by those skilled in the art that the foregoing and other changes in form and details may be made therein without departing from the spirit and scope of the invention. For example, the system and method of the present invention need not be limited solely to the workings of the Internet and the web browser, but also may be used for communicating between nodes on a computer network.

We claim:

1. A system for managing user specific-data, comprising:
a profile client associated with a user device, the user device having an Internet interface for accessing nodes on the Internet; and
a profile application programming interface allowing the profile client to access user-specific data from a profile server,
the profile client operable to retrieve the user-specific data associated with a user currently logged into the user device, the user-specific data retrieved from the profile server via the profile application programming interface, the profile client further operable to store the retrieved user-specific data on the user device to be used as user-specific data for the user when communicating to one or more nodes during the time the user is logged into the user device, ‘the profile client further operable to intercept data communicated from the user device to the one or more nodes, and insert the user-specific data, if any, in the data before the data is communicated to the one or more nodes,
the profile client also operable to intercept data communicated from the one or more nodes to the user device, and extract the user-specific data, if any, to store the user-specific data in the profile server,
wherein the user-specific data is maintained over multiple user sessions, independent of devices that the user uses to communicate with the one or more of the nodes on the Internet.

2. A system for managing user specific-data, comprising:
a profile client associated with a user device, the user device having an interface for accessing nodes on a distributed network;
a profile server operable to store user-specific data; and
a profile application programming interface operable to allow the profile client to access the user-specific data from a profile server,
the profile client operable to synchronize the user-specific data stored in the profile server and the user-specific data stored locally in the user device,
the profile client further operable to monitor the user-specific data stored locally in the user device, and the profile client operable in response to detecting a change in the user-specific data stored locally in the user device, transmitting the change to the profile server,
wherein the user-specific data corresponding to a user is maintained over multiple user sessions, independent of devices that the user uses to communicate with the one or more nodes on the distributed network.

3. A system for managing user specific-data, comprising:
a profile client associated with a user device, the user device having an Internet software for accessing nodes on the Internet;
a profile server operable to store user-specific data; and
a profile application programming interface operable to allow the profile client to access the user-specific data from the profile server,
the profile client operable to retrieve the user-specific data associated with a user currently logged into the user device, the user-specific data retrieved from the profile server via the profile application programming interface, the profile client further operable to store the retrieved user-specific data on the user device to be used as user-specific data for the user when communicating to one or more nodes during the time the user is logged into the user device,
the profile client further operable to detect and transmit to the profile server any additional user-specific data used in communicating between the user and the one or more nodes during a session,
wherein the user-specific data is maintained over multiple user sessions, independent of devices that the user uses to communicate with the one or more of the nodes on the Internet.

4. The system as claimed in claim 1, wherein the system further includes a profile server having one or more database for storing the user-specific data.

5. The system as claimed in claim 1, wherein the user-specific data is deleted from the user device after the user logs off from the user device.

6. The system as claimed in claim 2, wherein the profile client synchronizes the user-specific data periodically.

7. The system as claimed in claim 2, wherein the profile client continuously monitors the user-specific data.

8. The system as claimed in claim 3, wherein the profile server is operable to detect profile event changes and communicate the profile event changes to the profile client.

9. The system as claimed in claim 3, wherein the profile application programming interface includes one or more utilities for accessing the user specific-data on the profile server.

10. A method for managing user-specific data, comprising:
intercepting data communicated between a user operating from a user device and a node on network;
determining whether a user-specific data is included in the data;
extracting the user-specific data; and
transmitting the extracted user-specific data to a server for storage,
wherein the next time the user communicates to the node, the user-specific data can be retrieved and used regardless of which device the user is using for communicating to the node.

11. The method for managing user-specific data as claimed in claim 10, further including:
inserting the user-specific data in the data communicated from the user to the node.

12. The method for managing user-specific data as claimed in claim 10, further including:
retrieving user-specific data from the server when a user initiates a session on the user device; and
storing the user-specific data locally on the user device.

13. A method for managing user-specific data, comprising:
automatically synchronizing user profile settings stored locally on a user device with user-specific data stored in a server, the user-specific data associated with a user currently logged on the user device;
monitoring local user-specific data settings on the user device;
detecting changes in the local user-specific data settings; and
transmitting the changes to the server for storing as the user-specific data,
wherein the user-specific data stored in the server can be retrieved and used the next time the user logs in regardless of whether the user logs into the user device or another user device.

14. The method for managing user-specific data as claimed in claim 13, wherein the monitoring includes periodically monitoring local user-specific data settings on the user device.

15. The method for managing user-specific data as claimed in claim 13, wherein the monitoring includes continuously monitoring local user-specific data settings on the user device.

16. The method for managing user-specific data as claimed in claim 13, wherein the transmitting includes periodically transmitting the changes to the server for storing as the user-specific data.

17. A program storage device readable by machine, tangibly embodying a program of instructions executable by the machine to perform method steps of managing user-specific data, comprising
intercepting data communicated between a user operating from a user device and a node on a network;
determining whether a user-specific data is included in the data;
extracting the user-specific data; and
transmitting the extracted user-specific data to a server for storage,
wherein the next time the user communicates to the node, the user-specific data can be retrieved and used regardless of which device the user is using for communicating to the node.

18. The program storage device as claimed in claim 17, further including:
inserting the user-specific data in the data communicated from the user to the node.

19. The program storage device as claimed in claim 17, further including:
retrieving user-specific data from the server when a user initiates a session on the user device; and
storing the user-specific data locally on the user device.

20. A system for managing user specific-data, comprising:
a profile client associated with a user device, the user device having an Internet software for accessing nodes on the Internet;
a profile server operable to store user-specific data;
the profile client operable to retrieve the user-specific data associated with a user currently logged into the user device, the user-specific data retrieved from the profile server, the profile client further operable to store the retrieved user-specific data on the user device to be used as user-specific data for the user when communicating to one or more nodes during the time the user is logged into the user device,
the profile client further operable to detect and transmit to the profile server any additional user-specific data used in communicating between the user and the one or more nodes during a session,
wherein the user-specific data is maintained over multiple user sessions, independent of devices that the user uses to communicate with the one or more of the nodes on the Internet.
